(19) United States
(12) Patent Application Publication
(10) Pub. No.: US 2019/0265730 A1
(43) Pub. Date: Aug. 29, 2019

(54) CONTROL METHOD, CONTROL DEVICE AND ELECTRONIC DEVICE

(71) Applicant: SZ DJI TECHNOLOGY CO., LTD., Shenzhen (CN)

(72) Inventors: Pu XU, Shenzhen (CN); Guanhua SU, Shenzhen (CN); Cheng ZOU, Shenzhen (CN); Chengwei ZHU, Shenzhen (CN); Di WU, Shenzhen (CN)

(21) Appl. No.: 16/411,343

(22) Filed: May 14, 2019

Related U.S. Application Data
(63) Continuation of application No. PCT/CN2016/105770, filed on Nov. 14, 2016.

(51) Int. Cl. G05D 1/08; G08G 5/00; B64C 39/02

(52) U.S. Cl. CPC G05D 1/0808; G08G 5/0047; B64C 2201/146; B64C 39/024; B64C 2201/141; G08G 5/0017

(57) ABSTRACT

A control method includes receiving status information of the aerial vehicle, obtaining a flight path of the aerial vehicle based on the status information, and displaying a three-dimensional (3D) dynamic icon corresponding to the flight path.

### CROSS-REFERENCE TO RELATED APPLICATION

This application is a continuation of International Application No. PCT/CN2016/105770, filed on Nov. 14, 2016, the entire content of which is incorporated herein by reference.

### TECHNICAL FIELD

The present disclosure relates to consumer electronics technology and, more particularly, to a control method, a control device, and an electronic device.

### BACKGROUND

With the rapid development of technologies, smart phones, tablet computers, and other electronic devices are widely used, for example, in remotely monitoring or controlling aerial vehicles. Currently, when an electronic device remotely monitors or controls an aerial vehicle, it is unable to show a sense of depth when displaying a flight path of the remotely monitored or controlled aerial vehicle, and the user experience is poor.

### SUMMARY

In accordance with the disclosure, there is provided a control method including receiving status information of the aerial vehicle, obtaining a flight path of the aerial vehicle based on the status information, and displaying a three-dimensional (3D) dynamic icon corresponding to the flight path.

Also in accordance with the disclosure, there is provided a control device including a communication circuit configured to receive status information of the aerial vehicle, a processor configured to obtain a flight path of the aerial vehicle based on the status information, and a display configured to display a three-dimensional (3D) dynamic icon corresponding to the flight path.

### BRIEF DESCRIPTION OF THE DRAWINGS

To more clearly illustrate the technical solutions of the present disclosure, the accompanying drawings to be used in the description of the disclosed embodiments are briefly described below.

FIG. 1 is a flow chart of a control method according to some embodiments of the present disclosure.

FIG. 2 is a schematic diagram of an electronic device and a control device according to some embodiments of the present disclosure.

FIG. 3 is a schematic diagram of an electronic device and an aerial vehicle according to some embodiments of the present disclosure.

FIG. 4 is a flow chart of another control method according to some embodiments of the present disclosure.

FIG. 5 is a flow chart of another control method according to some embodiments of the present disclosure.

FIG. 6 is a flow chart of another control method according to some embodiments of the present disclosure.

FIG. 7 is a flow chart of another control method according to some embodiments of the present disclosure.

FIG. 8 is a flow chart of another control method according to some embodiments of the present disclosure.

FIG. 9 is a schematic diagram of a display interface of an electronic device display according to some embodiments of the present disclosure.

FIG. 10 is a schematic diagram of another display interface of an electronic device display according to some embodiments of the present disclosure.

FIG. 11 is a schematic diagram of another display interface of an electronic device display according to some embodiments of the present disclosure.

FIG. 12 is a schematic diagram of another display interface of an electronic device display according to some embodiments of the present disclosure.

FIG. 13 is a schematic diagram of another display interface of an electronic device display according to some embodiments of the present disclosure.

FIG. 14 is a schematic diagram of another display interface of an electronic device display according to some embodiments of the present disclosure.

FIG. 15 is a schematic diagram of another display interface of an electronic device display according to some embodiments of the present disclosure.

FIG. 16 is a schematic diagram of another display interface of an electronic device display according to some embodiments of the present disclosure.

### DETAILED DESCRIPTION OF THE EMBODIMENTS

Hereinafter, embodiments consistent with the present disclosure will be described with reference to drawings. Wherever possible, the same reference numerals will be used throughout the drawings to refer to the same or like parts. The embodiments described below with reference to the drawings are example, are used to explain the present disclosure, and should not be construed as limiting the present disclosure.

It should be understood that, in the description of the present disclosure, the terms “first” and “second” are used for illustrative purposes only and are not to be construed as indicating or implying relative importance or implicitly indicating a number of indicated technical features. Thus, the features defined by the terms “first” and “second” may explicitly or implicitly include one or more of the features. In the description of the present disclosure, the meaning of “plurality” is two or more, unless specifically defined otherwise.

It should be understood that, in the description of the present disclosure, the terms “mounting” and “connecting” are used in a broad sense unless specifically defined otherwise. For example, the terms may refer to fixedly connecting, removably connecting, or integrally connecting. The terms may refer to mechanically connecting, electrically connecting, or connecting to communicate with each other. The terms may refer to directly connecting, indirectly connecting through an intermediate object, internally connecting between two components, or interactively connecting between two components. Those having ordinary skill in the art can understand the specific meanings of the terms under specific contexts in the present disclosure.

Various example embodiments of the present disclosure will now be described in detail for implementing various structures of the present disclosure. To simplify the description of the present disclosure, components and configurations of specific embodiments are described below. Of course, the embodiments are intended to be illustrative, and not to limit the scope of the present disclosure. In addition, the reference numerals and/or reference letters may be repeatedly used in different embodiments of the present disclosure. The repetition is for the purpose of simplification and clarity, and does not itself indicate any relationship between various embodiments and/or configurations in the description. Further, the present disclosure provides examples of various specific processes and materials. However, those having ordinary skill in the art may be aware of the application of alternative processes and/or the use of alternative materials.

Various embodiments of the present disclosure will be described below in detail. The embodiments are illustrated with reference to the accompanying drawings. The same or similar reference numerals through the drawings denote the same or similar elements or elements having the same or similar functions. The embodiments described below with reference to the drawings are intended to be illustrative, are used to explain the present disclosure, and should not be construed as limiting the present disclosure.

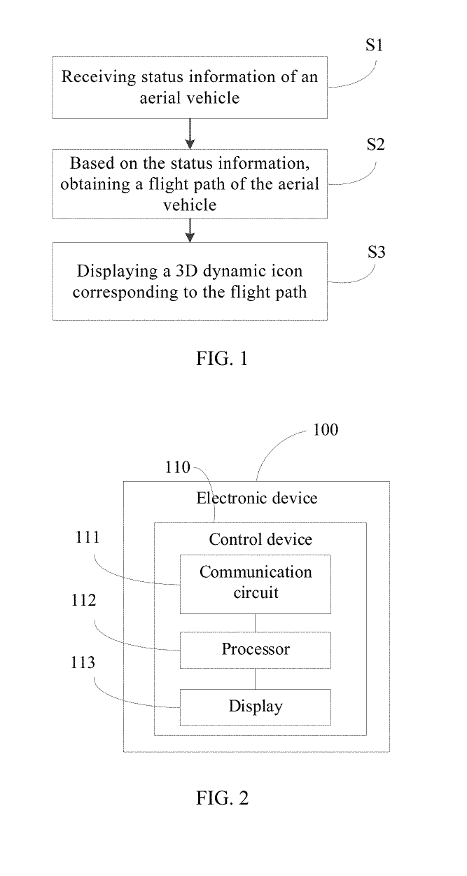

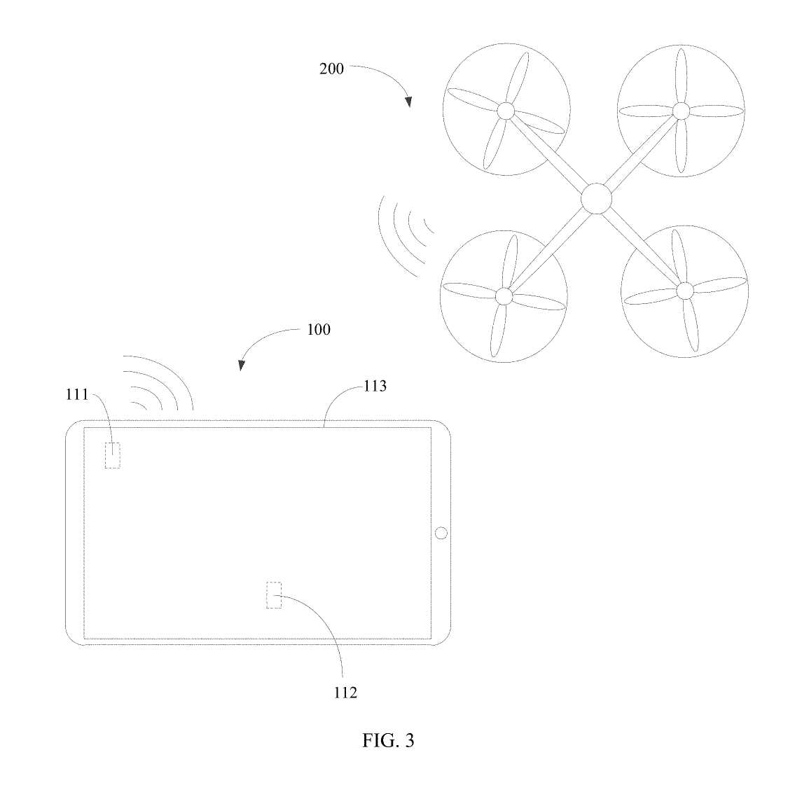

Referring to FIGS. 1-3 and FIGS. 9 and 10, the present disclosure provides a control method, which can be implemented in a control device 110 for controlling an electronic device 100. The electronic device 100 may communicate with an aerial vehicle 200. The control method includes: receiving status information of the aerial vehicle 200 (S1), obtaining a flight path of the aerial vehicle 200 based on the status information (S2), and displaying a three-dimensional dynamic icon 101 corresponding to the flight path (S3). The process of obtaining the flight path is described in more detail below.

In some embodiments, when the aerial vehicle 200 is flying in an autonomous flight mode, the flight path of the aerial vehicle 200 may be planned in advance by an autonomous flight circuit in the aerial vehicle 200 or an autonomous flight circuit in the electronic device 100. In these embodiments, the status information may include a planned path that the autonomous flight circuit plans in advance. Correspondingly, the process of obtaining the flight path of the aerial vehicle 200 based on the status information may include directly retrieving the planned path from the status information.

In some embodiments, when the aerial vehicle 200 is flying in a manually controlled flight mode, the flight path of the aerial vehicle 200 may be predicted by a path prediction circuit of the aerial vehicle 200 according to a real-time flying path. In these embodiments, the status information may include a future path that the path prediction circuit of the aerial vehicle 200 predicts. Correspondingly, the process of obtaining the flight path of the aerial vehicle 200 based on the status information may include directly retrieving the future path from the status information.

In some embodiments, when the aerial vehicle 200 is flying in a manually controlled flight mode, the aerial vehicle 200 may record its own real-time flying path. In these embodiments, the status information may include the real-time flying path of the aerial vehicle 200. Correspondingly, the process of obtaining the flight path of the aerial vehicle 200 based on the status information may include retrieving the real-time flying path and predicting a future path of the aerial vehicle 200 based on the real-time flying path. In these embodiments, the path prediction circuit is located outside the aerial vehicle 200.

The present disclosure provides a control device 110. Referring to FIG. 2, the control device 110 includes a communication circuit 111, a processor 112, and a display 113 to implement the control method including S1, S2, and S3. For example, the communication circuit 111 can be configured to receive the status information of the aerial vehicle 200. The processor 112 can be configured to obtain the flight path based on the status information. The display 113 can be configured to display the three-dimensional dynamic icon 101 corresponding to the flight path. The processor 112 can obtain the flight path according to any of the methods described above, the detailed description of which is not repeated here.

The control device 110 of the present disclosure may be implemented in the electronic device 100 of the present disclosure.

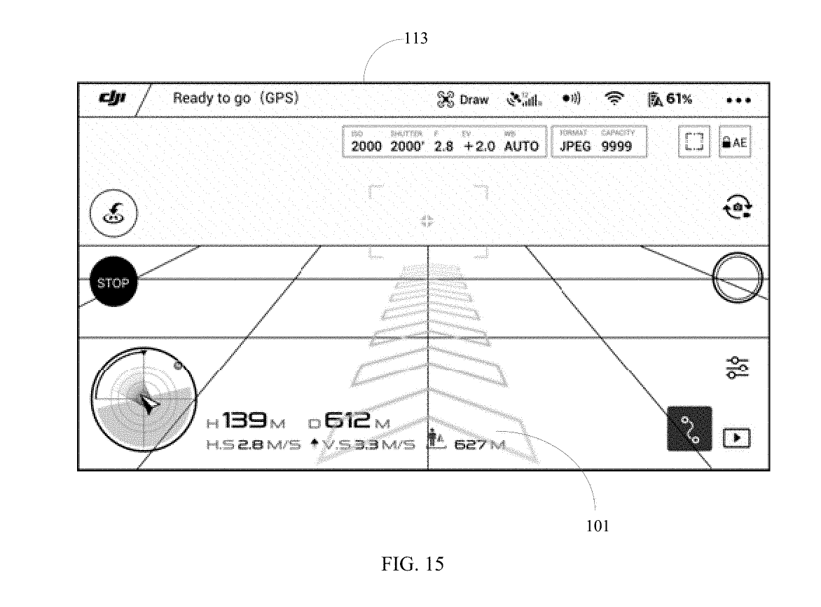

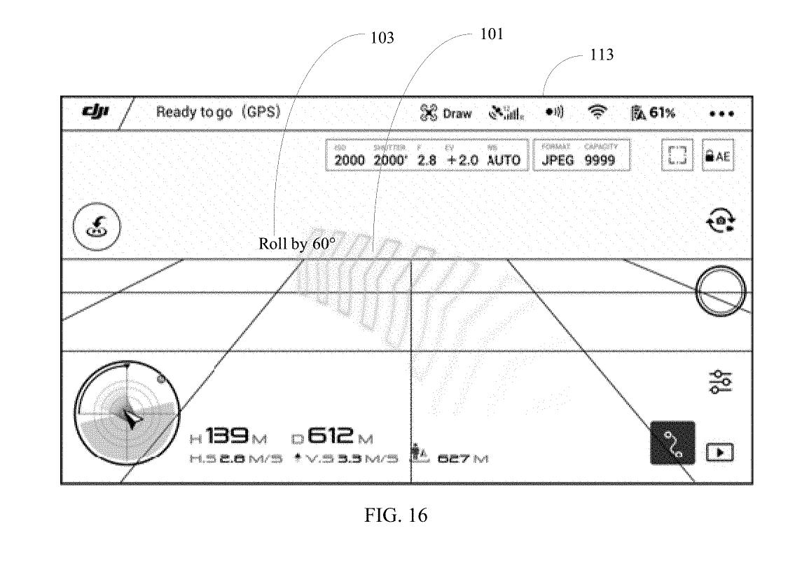

The electronic device 100 may include one or more of a smart phone, a tablet computer, a remote controller (e.g., a remote controller having a display), a smart watch, smart glasses, a smart helmet, other virtual reality wearable device, other augmented reality wearable device, or other display terminal having a display function. As shown in FIGS. 15 and 16, in addition to display the three-dimensional (3D) dynamic icon 101 corresponding to the flight path, the display 113 of the electronic device 100 can also display other related information of the aerial vehicle that is monitored or controlled, such as model number and parameter information of the aerial vehicle 200, flight parameters of the aerial vehicle 200, images or videos captured by the aerial vehicle 200, and interface information for controlling the aerial vehicle 200.

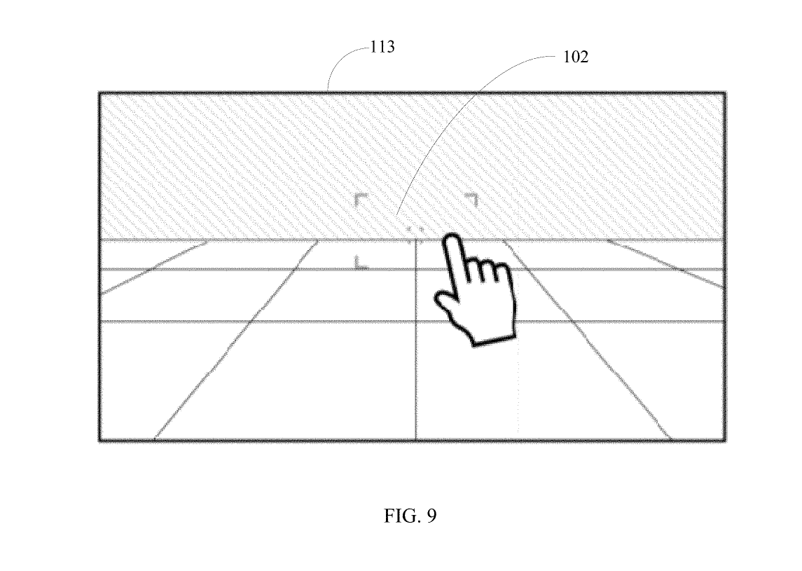

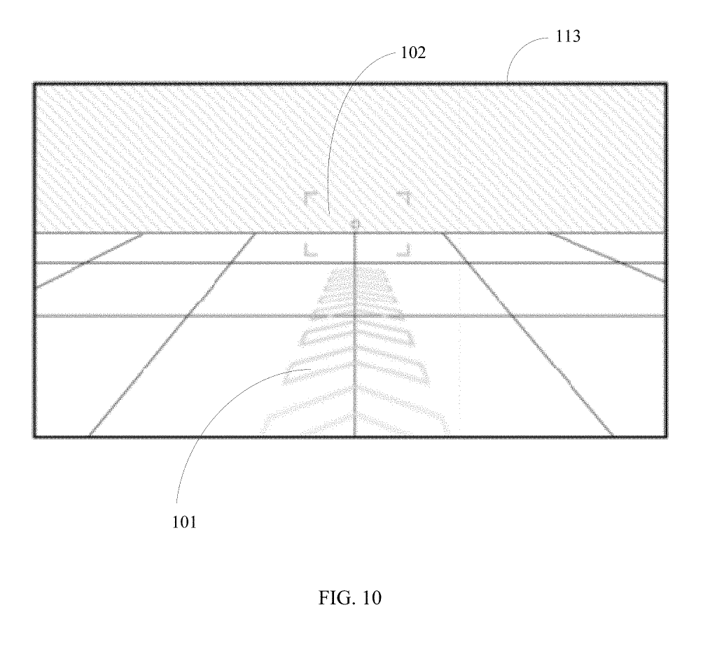

The following example illustrates displaying the 3D dynamic icon 101 corresponding to the flight path. Referring to FIG. 9, a user clicks on any position of the display 113. The display 113 displays a cursor 102 that locks a direction. The communication circuit 111 receives the status information of the aerial vehicle 200. The processor 112 obtains the flight path of the aerial vehicle 200 based on the status information. The method of obtaining the flight path can be any of the methods described above. Referring to FIG. 10, the display 113 displays a 3D dynamic icon 101 corresponding to the flight path. As such, the flight path of the aerial vehicle 200 may be known by observing the 3D dynamic icon 101 displayed on the display 113. The 3D dynamic icon 101 may be in bright colors and arrow-shaped, and may gradually become narrower in a depth direction of the display 113. In some embodiments, the 3D dynamic icon 101 may include a plurality of sub-arrows that are arranged sequentially and separated from each other. In some embodiments, tips of the sub-arrows of the 3D dynamic icon 101 may fade away one by one into the flying direction. In some embodiments, the 3D dynamic icon 101 may not be in bright colors, but in somewhat vivid colors, such as visually impactful red, green, or yellow. In some embodiments, the 3D dynamic icon 101 may be in any other colors or in simple or gradient combination of a plurality of colors, as long as the sufficient indication is provided to the user. The 3D dynamic icon 101 may not be limited to arrow-shaped, but may be triangle-shaped, trapezoid-shaped, or rolling column-shaped.

The control method, the control device 110, and the electronic device 100 of the present disclosure may control the display 113 to intelligently display the 3D dynamic icon 101 showing the flight path of the aerial vehicle 200 with a perception of depth. As such, when the user monitors or operates the aerial vehicle 200, the user may perceive the depth of the view and enjoy an improved user experience. When displaying in combination with the images captured and uploaded by the aerial vehicle 200, the user may have an immersive feeling, which substantially improves the user experience.

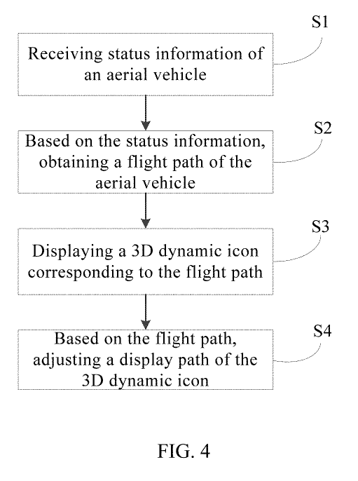

Referring to FIG. 2, FIG. 4, and FIGS. 9-11, the control method of the present disclosure is implemented in the control device 110 to control the electronic device 100. The electronic device 100 communicates with the aerial vehicle 200. The control method includes: receiving status information of the aerial vehicle 200 (S1), obtaining a flight path of the aerial vehicle 200 based on the status information (S2), displaying a 3D dynamic icon 101 corresponding to the flight path (S3), and adjusting the display path of the 3D dynamic icon 101 based on the flight path (S4). The process of obtaining the flight path is described in more detail below.

In some embodiments, when the aerial vehicle 200 is flying in an autonomous flight mode, the flight path of the aerial vehicle 200 may be planned in advance by an autonomous flight circuit in the aerial vehicle 200 or an autonomous flight circuit in the electronic device 100. In these embodiments, the status information may include a planned path that the autonomous flight circuit plans in advance. Correspondingly, the process of obtaining the flight path of the aerial vehicle 200 based on the status information may include directly retrieving the planned path from the status information.

In some embodiments, when the aerial vehicle 200 is flying in a manually controlled flight mode, the flight path of the aerial vehicle 200 may be predicted by a path prediction circuit of the aerial vehicle 200 according to a real-time flying path. In these embodiments, the status information may include a future path that the path prediction circuit of the aerial vehicle 200 predicts. Correspondingly, the process of obtaining the flight path of the aerial vehicle 200 based on the status information may include directly retrieving the future path from the status information.

In some embodiments, when the aerial vehicle 200 is flying in a manually controlled flight mode, the aerial vehicle 200 may record its own real-time flying path. In these embodiments, the status information may include the real-time flying path of the aerial vehicle 200. Correspondingly, the process of obtaining the flight path of the aerial vehicle 200 based on the status information may include retrieving the real-time flying path and predicting a future path of the aerial vehicle 200 based on the real-time flying path. In these embodiments, the path prediction circuit is located outside the aerial vehicle 200.

The present disclosure provides a control device 110. Referring to FIG. 2, the control device 110 includes a communication circuit 111, a processor 112, and a display 113. The communication circuit 111 can be configured to implement S1. The processor 112 can be configured to implement S2 and S4. The display 113 can be configured to implement S3. For example, the communication circuit 111 can be configured to receive the status information of the aerial vehicle 200. The processor 112 can be configured to obtain the flight path based on the status information and to adjust the display path of the 3D dynamic icon 101 based on the flight path. The display 113 can be configured to display the three-dimensional dynamic icon 101 corresponding to the flight path. The processor 112 can obtain the flight path according to any of the methods described above, the detailed description of which is not repeated here.

The control device 110 of the present disclosure may be implemented in the electronic device 100 of the present disclosure. The electronic device 100 may include one or more of a smart phone, a tablet computer, a remote controller (e.g., a remote controller having a display), a smart watch, smart glasses, a smart helmet, other virtual reality wearable device, other augmented reality wearable device, or other display terminal having a display function. As shown in FIGS. 15 and 16, in addition to display the 3D dynamic icon 101 corresponding to the flight path, the display 113 of the electronic device 100 can also display other related information of the aerial vehicle that is monitored or controlled, such as model number and parameter information of the aerial vehicle 200, flight parameters of the aerial vehicle 200, images or videos captured by the aerial vehicle 200, and interface information for controlling the aerial vehicle 200.

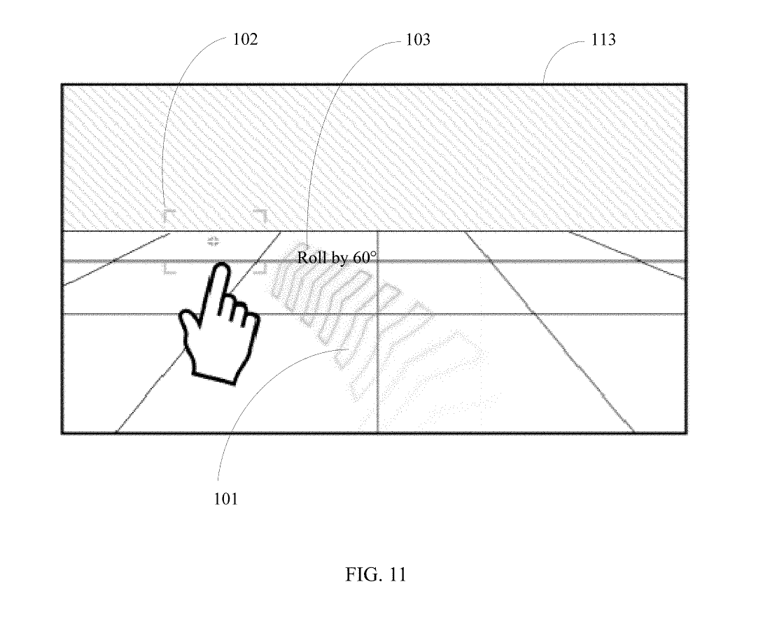

The following example illustrates displaying the 3D dynamic icon 101 corresponding to the flight path and adjusting the display path of the 3D dynamic icon 101 based on the flight path. Referring to FIG. 9, a user clicks on any position of the display 113. The display 113 displays a cursor 102 that locks a direction. The communication circuit 111 receives the status information of the aerial vehicle 200. The processor 112 obtains the flight path of the aerial vehicle 200 based on the status information. The method of obtaining the flight path can be any of the methods described above. Referring to FIG. 10, the display 113 displays a 3D dynamic icon 101 corresponding to the flight path. As such, the flight path of the aerial vehicle 200 may be known by observing the 3D dynamic icon 101 displayed on the display 113. When the flight path of the aerial vehicle 200 needs to be changed, as shown in FIG. 11, the user clicks on another position of the display 113, and the flight path of the aerial vehicle 200 changes accordingly. The processor 112 adjusts the display path of the 3D dynamic icon 101 based on the flight path from a straight path in FIG. 10 to a curved path in FIG. 11.

The 3D dynamic icon 101 may be in bright colors and arrow-shaped, and may gradually become narrower in a depth direction of the display 113. In some embodiments, the 3D dynamic icon 101 may include a plurality of sub-arrows that are arranged sequentially and separated from each other. In some embodiments, tips of the sub-arrows of the 3D dynamic icon 101 may fade away one by one into the flying direction. In some embodiments, the 3D dynamic icon 101 may not be in bright colors, but in somewhat vivid colors, such as visually impactful red, green, or yellow. In some embodiments, the 3D dynamic icon 101 may be in any other colors or in simple or gradient combination of a plurality of colors, as long as the sufficient indication is provided to the user. The 3D dynamic icon 101 may not be limited to arrow-shaped, but may be triangle-shaped, trapezoid-shaped, or rolling column-shaped.

The control method, the control device 110, and the electronic device 100 of the present disclosure may control the display 113 to intelligently display the 3D dynamic icon 101 showing the flight path of the aerial vehicle 200 with a perception of depth. As such, when the user monitors or operates the aerial vehicle 200, the user may perceive the depth of the view and enjoy an improved user experience. When displaying in combination with the images captured and uploaded by the aerial vehicle 200, the user may have an immersive feeling, which substantially improves the user experience. Moreover, the processor 112 may adjust the display path of the 3D dynamic icon 101 based on the flight path of the aerial vehicle 200. The user may intuitively perceive the flight path of the aerial vehicle 200 by following the display path of the 3D dynamic icon 101. Thus, the user experience is improved.

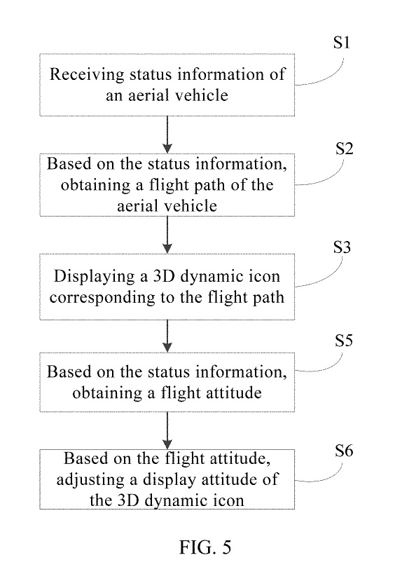

Referring to FIG. 2, FIG. 5, FIGS. 9 and 10, and FIGS. 12-14, the control method of the present disclosure is implemented in the control device 110 to control the electronic device 100. The electronic device 100 communicates with the aerial vehicle 200. The control method includes: receiving status information of the aerial vehicle 200 (S1), obtaining a flight path of the aerial vehicle 200 based on the status information (S2), displaying a 3D dynamic icon 101 corresponding to the flight path (S3), obtaining a flight attitude based on the status information (S5), and adjusting the display attitude of the 3D dynamic icon 101 based on the flight attitude (S6). The process of obtaining the flight path is described in more detail below.

In some embodiments, when the aerial vehicle 200 is flying in an autonomous flight mode, the flight path of the aerial vehicle 200 may be planned in advance by an autonomous flight circuit in the aerial vehicle 200 or an autonomous flight circuit in the electronic device 100. In these embodiments, the status information may include a planned path that the autonomous flight circuit plans in advance. Correspondingly, the process of obtaining the flight path of the aerial vehicle 200 based on the status information may include directly retrieving the planned path from the status information.

In some embodiments, when the aerial vehicle 200 is flying in a manually controlled flight mode, the flight path of the aerial vehicle 200 may be predicted by a path prediction circuit of the aerial vehicle 200 according to a real-time flying path. In these embodiments, the status information may include a future path that the path prediction circuit of the aerial vehicle 200 predicts. Correspondingly, the process of obtaining the flight path of the aerial vehicle 200 based on the status information may include directly retrieving the future path from the status information.

In some embodiments, when the aerial vehicle 200 is flying in a manually controlled flight mode, the aerial vehicle 200 may record its own real-time flying path. In these embodiments, the status information may include the real-time flying path of the aerial vehicle 200. Correspondingly, the process of obtaining the flight path of the aerial vehicle 200 based on the status information may include retrieving the real-time flying path and predicting a future path of the aerial vehicle 200 based on the real-time flying path. In these embodiments, the path prediction circuit is located outside the aerial vehicle 200.

The flight attitude of the aerial vehicle 200 can include a pitch angle, a roll angle, and a yaw angle. The processes of obtaining the flight attitude and adjusting the display attitude are described in more detail below.

In some embodiments, the pitch angle of the aerial vehicle 200 is obtained based on the status information. Adjusting the display attitude of the 3D dynamic icon based on the flight attitude includes adjusting the pitch angle of the 3D dynamic icon 101 based on the pitch angle of the aerial vehicle 200.

In some embodiments, the roll angle of the aerial vehicle 200 is obtained based on the status information. Adjusting the display attitude of the 3D dynamic icon based on the flight attitude includes adjusting the roll angle of the 3D dynamic icon 101 based on the roll angle of the aerial vehicle 200.

In some embodiments, the yaw angle of the aerial vehicle 200 is obtained based on the status information. Adjusting the display attitude of the 3D dynamic icon based on the flight attitude includes adjusting the yaw angle of the 3D dynamic icon 101 based on the yaw angle of the aerial vehicle 200.

In some embodiments, the pitch angle and the roll angle of the aerial vehicle 200 are obtained based on the status information. Adjusting the display attitude of the 3D dynamic icon based on the flight attitude includes adjusting the pitch angle and the roll angle of the 3D dynamic icon 101 based on the pitch angle and the roll angle of the aerial vehicle 200.

In some embodiments, the pitch angle and the yaw angle of the aerial vehicle 200 are obtained based on the status information. Adjusting the display attitude of the 3D dynamic icon based on the flight attitude includes adjusting the pitch angle and the yaw angle of the 3D dynamic icon 101 based on the pitch angle and the yaw angle of the aerial vehicle 200.

In some embodiments, the roll angle and the yaw angle of the aerial vehicle 200 are obtained based on the status information. Adjusting the display attitude of the 3D dynamic icon based on the flight attitude includes adjusting the roll angle and the yaw angle of the 3D dynamic icon 101 based on the roll angle and the yaw angle of the aerial vehicle 200.

In some embodiments, the pitch angle, the roll angle, and the yaw angle of the aerial vehicle 200 are obtained based on the status information. Adjusting the display attitude of the 3D dynamic icon based on the flight attitude includes adjusting the pitch angle, the roll angle, and the yaw angle of the 3D dynamic icon 101 based on the pitch angle, the roll angle, and the yaw angle of the aerial vehicle 200.

In the example methods described above, the adjustment of an angle of the 3D dynamic icon 101 may be equal to the adjustment of a corresponding angle of the aerial vehicle 200. That is, the change of the angle of the aerial vehicle 200 may be equal to the change of the corresponding angle of the 3D dynamic icon 101. For example, when the aerial vehicle 200 tilts up by about 60°, the 3D dynamic icon 101 also tilts up by about 60°. When the aerial vehicle 200 tilts down by about 60°, the 3D dynamic icon 101 also tilts down by about 60°.

In some embodiments, the adjustment of an angle of the 3D dynamic icon 101 may be proportional to the adjustment of a corresponding angle of the aerial vehicle 200 at a pre-determined ratio. For example, the pre-determined ratio may be 2:1. When the aerial vehicle 200 tilts up by about 60°, the 3D dynamic icon 101 may tilt up by about 30°. When the aerial vehicle 200 tilts down by about 60°, the 3D dynamic icon 101 may tilt down by about 30°.

In some embodiments, the adjustment of an angle of the 3D dynamic icon 101 may have a pre-determined mapping relationship with the adjustment of a corresponding angle of the aerial vehicle 200. For example, when the aerial vehicle 200 tilts up by about 60°, the 3D dynamic icon 101 may tilt up by about 30° according to a pre-determined mapping relationship. When the aerial vehicle 200 tilts down by about 60°, the 3D dynamic icon 101 may tilt down by about 30° according to the pre-determined mapping relationship.

In some embodiments, a fixed angle of the 3D dynamic icon 101 may be set for a corresponding angle of the aerial vehicle 200 in a certain range. For example, when the aerial vehicle 200 tilts up by an angle in a range between about 0° and about 30°, the 3D dynamic icon 101 may tilt up by about 15°. When the aerial vehicle 200 tilts up by an angle in a range between about 30° and about 60°, the 3D dynamic icon 101 may tilt up by about 30°. When the aerial vehicle 200 tilts up by an angle in a range between about 60° and about 90°, the 3D dynamic icon 101 may tilt up by about 60°.

When the adjustment of an angle of the 3D dynamic icon 101 is equal to the adjustment of a corresponding angle of the aerial vehicle 200, the user may synchronously perceive the attitude change of the aerial vehicle 200.

In some embodiments, the user may input various angles to control the angle adjustments. For example, the user may enter a 30° pitch angle, a 50° roll angle, and a 60° yaw angle. When the aerial vehicle 200 has a non-zero pitch angle, the 3D dynamic icon 101 may always tilt by about 30° regardless of the actual value of the pitch angle of the aerial vehicle 200. When the aerial vehicle 200 has a non-zero roll angle, the 3D dynamic icon 101 may always roll by about 50° regardless of the actual value of the roll angle of the aerial vehicle 200. When the aerial vehicle 200 has a non-zero yaw angle, the 3D dynamic icon 101 always yaws by about 60° regardless of the actual value of the yaw angle of the aerial vehicle 200.

Referring to FIG. 2, in some embodiments, the control device 110 includes a communication circuit 111, a processor 112, and a display 113. The communication circuit 111 can be configured to implement S1. The processor 112 can be configured to implement S2, S5, and S6. The display 113 can be configured to implement S3. For example, the communication circuit 111 can be configured to receive the status information of the aerial vehicle 200. The processor 112 can be configured to obtain the flight path based on the status information, to obtain the flight attitude based on the status information, and to adjust the display attitude of the 3D dynamic icon 101 based on the flight attitude. The display 113 can be configured to display the 3D dynamic icon 101 corresponding to the flight path. The processor 112 can obtain the flight path according to any of the methods described above, and adjusting the display attitude of the 3D dynamic icon 101 based on the flight attitude can be performed according to any of the methods described above, the detailed descriptions of both of which are not repeated here.

The control device 110 of the present disclosure may be implemented in the electronic device 100 of the present disclosure. The electronic device 100 may include one or more of a smart phone, a tablet computer, a remote controller (e.g., a remote controller having a display), a smart watch, smart glasses, a smart helmet, other virtual reality wearable device, other augmented reality wearable device, or other display terminal having a display function. As shown in FIGS. 15 and 16, in addition to display the 3D dynamic icon 101 corresponding to the flight path, the display 113 of the electronic device 100 can also display other related information of the aerial vehicle that is monitored or controlled, such as model number and parameter information of the aerial vehicle 200, flight parameters of the aerial vehicle 200, images or videos captured by the aerial vehicle 200, and interface information for controlling the aerial vehicle 200.

The following example illustrates displaying the 3D dynamic icon 101 corresponding to the flight path and adjusting the 3D dynamic icon 101 corresponding to the flight path based on the flight attitude. Referring to FIG. 9, a user clicks on any position of the display 113. The display 113 displays a cursor 102 that locks a direction. The communication circuit 111 receives the status information of the aerial vehicle 200. The processor 112 obtains the flight path of the aerial vehicle 200 based on the status information. The method of obtaining the flight path can be any of the methods described above. Referring to FIG. 10, the display 113 displays a 3D dynamic icon 101 corresponding to the flight path. As such, the flight path of the aerial vehicle 200 may be known by observing the 3D dynamic icon 101 displayed on the display 113.

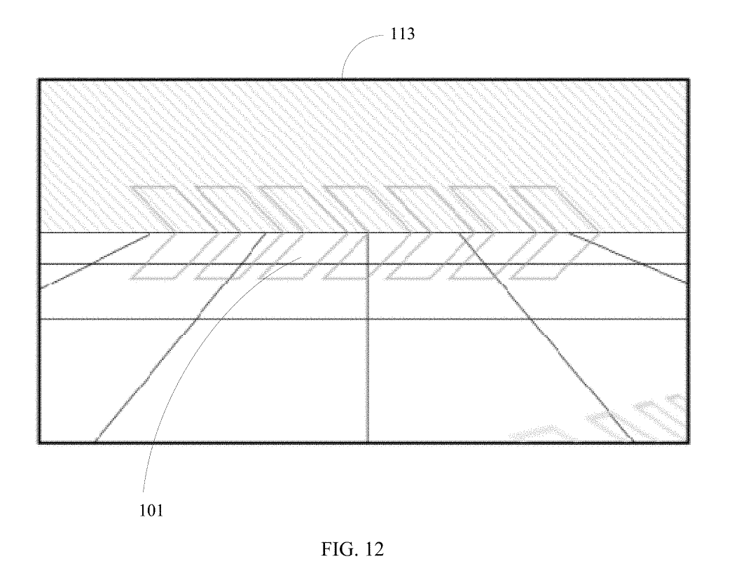

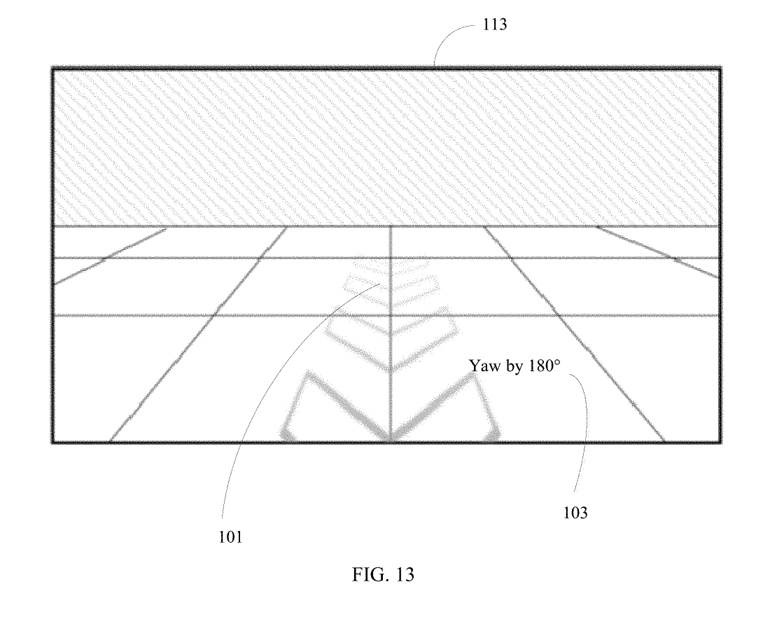

When the flight attitude of the aerial vehicle 200 changes, the processor 112 may adjust the display attitude of the 3D dynamic icon 101 based on the flight attitude. For example, when the aerial vehicle 200 yaws and the nose of the aerial vehicle 200 faces toward a direction other than the flying direction, the processor 112 obtains the yaw angle, and correspondingly, the 3D dynamic icon 101 also yaws with a corresponding angle (as shown in FIG. 12). When the aerial vehicle 200 yaws by about 180°, correspondingly, the 3D dynamic icon 101 also yaws by about 180 (as shown in FIG. 13), and the display path of the 3D dynamic icon 101 gradually fades away at a pace proportional to the flying forward speed of the aerial vehicle 200.

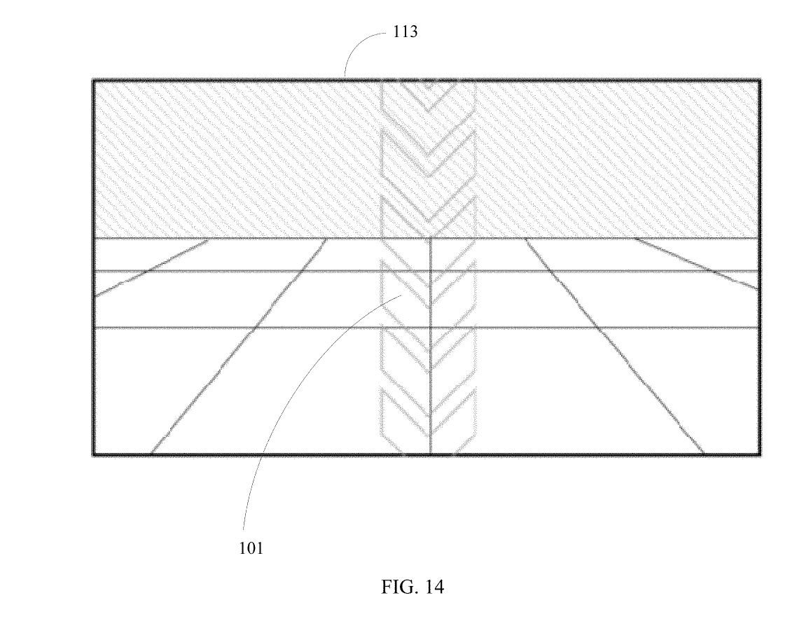

In some embodiments, when the user controls push down the throttle of the remote control, the transparency of the originally-displayed path of the 3D dynamic icon 101 is decreased, and a downward arrow is looming (this change can be reflected from FIG. 13 to FIG. 14). When the user pulls up the throttle of the remote control, the transparency of the originally-displayed path of the 3D dynamic icon 101 is decreased, and an upward arrow is looming.

The 3D dynamic icon 101 may be in bright colors and arrow-shaped, and may gradually become narrower in a depth direction of the display 113. In some embodiments, the 3D dynamic icon 101 may include a plurality of sub-arrows that are arranged sequentially and separated from each other. In some embodiments, tips of the sub-arrows of the 3D dynamic icon 101 may fade away one by one into the flying direction. In some embodiments, the 3D dynamic icon 101 may not be in bright colors, but in somewhat vivid colors, such as visually impactful red, green, or yellow. In some embodiments, the 3D dynamic icon 101 may be in any other colors or in simple or gradient combination of a plurality of colors, as long as the sufficient indication is provided to the user. The 3D dynamic icon 101 may not be limited to arrow-shaped, but may be triangle-shaped, trapezoid-shaped, or rolling column-shaped.

The control method, the control device 110, and the electronic device 100 of the present disclosure may control the display 113 to intelligently display the 3D dynamic icon 101 showing the flight path of the aerial vehicle 200 with a perception of depth. As such, when the user monitors or operates the aerial vehicle 200, the user may perceive the depth of the view and enjoy an improved user experience. When displaying in combination with the images captured and uploaded by the aerial vehicle 200, the user may have an immersive feeling, which substantially improves the user experience. Moreover, the processor 112 may adjust the display attitude of the 3D dynamic icon 101 based on the flight attitude of the aerial vehicle 200. The user may intuitively perceive the flight attitude of the aerial vehicle 200 by following the display attitude of the 3D dynamic icon 101. Thus, the user experience is further improved.

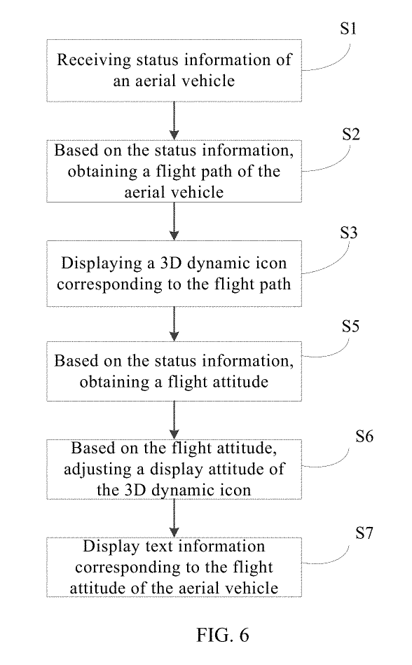

Referring to FIG. 2, FIG. 6, FIGS. 9 and 10, and FIGS. 12 and 13, the control method of the present disclosure is implemented in the control device 110 to control the electronic device 100. The electronic device 100 communicates with the aerial vehicle 200. The control method includes: receiving status information of the aerial vehicle 200 (S1), obtaining a flight path of the aerial vehicle 200 based on the status information (S2), displaying a 3D dynamic icon 101 corresponding to the flight path (S3), obtaining a flight attitude based on the status information (S5), adjusting the display attitude of the 3D dynamic icon 101 based on the flight attitude (S6), and displaying text information 103 corresponding to the flight attitude of the aerial vehicle 200 (S7). The process of obtaining the flight path is described in more detail below.

In some embodiments, when the aerial vehicle 200 is flying in an autonomous flight mode, the flight path of the aerial vehicle 200 may be planned in advance by an autonomous flight circuit in the aerial vehicle 200 or an autonomous flight circuit in the electronic device 100. In these embodiments, the status information may include a planned path that the autonomous flight circuit plans in advance. Correspondingly, the process of obtaining the flight path of the aerial vehicle 200 based on the status information may include directly retrieving the planned path from the status information.

In some embodiments, when the aerial vehicle 200 is flying in a manually controlled flight mode, the flight path of the aerial vehicle 200 may be predicted by a path prediction circuit of the aerial vehicle 200 according to a real-time flying path. In these embodiments, the status information may include a future path that the path prediction circuit of the aerial vehicle 200 predicts. Correspondingly, the process of obtaining the flight path of the aerial vehicle 200 based on the status information may include directly retrieving the future path from the status information.

In some embodiments, when the aerial vehicle 200 is flying in a manually controlled flight mode, the aerial vehicle 200 may record its own real-time flying path. In these embodiments, the status information may include the real-time flying path of the aerial vehicle 200. Correspondingly, the process of obtaining the flight path of the aerial vehicle 200 based on the status information may include retrieving the real-time flying path and predicting a future path of the aerial vehicle 200 based on the real-time flying path. In these embodiments, the path prediction circuit is located outside the aerial vehicle 200.

The flight attitude of the aerial vehicle 200 can include a pitch angle, a roll angle, and a yaw angle. The processes of obtaining the flight attitude and adjusting the display attitude are described in more detail below.

In some embodiments, the pitch angle of the aerial vehicle 200 is obtained based on the status information. Adjusting the display attitude of the 3D dynamic icon based on the flight attitude includes adjusting the pitch angle of the 3D dynamic icon 101 based on the pitch angle of the aerial vehicle 200.

In some embodiments, the roll angle of the aerial vehicle 200 is obtained based on the status information. Adjusting the display attitude of the 3D dynamic icon based on the flight attitude includes adjusting the roll angle of the 3D dynamic icon 101 based on the roll angle of the aerial vehicle 200.

In some embodiments, the yaw angle of the aerial vehicle 200 is obtained based on the status information. Adjusting the display attitude of the 3D dynamic icon based on the flight attitude includes adjusting the yaw angle of the 3D dynamic icon 101 based on the yaw angle of the aerial vehicle 200.

In some embodiments, the pitch angle and the roll angle of the aerial vehicle 200 are obtained based on the status information. Adjusting the display attitude of the 3D dynamic icon based on the flight attitude includes adjusting the pitch angle and the roll angle of the 3D dynamic icon 101 based on the pitch angle and the roll angle of the aerial vehicle 200.

In some embodiments, the pitch angle and the yaw angle of the aerial vehicle 200 are obtained based on the status information. Adjusting the display attitude of the 3D dynamic icon based on the flight attitude includes adjusting the pitch angle and the yaw angle of the 3D dynamic icon 101 based on the pitch angle and the yaw angle of the aerial vehicle 200.

In some embodiments, the roll angle and the yaw angle of the aerial vehicle 200 are obtained based on the status information. Adjusting the display attitude of the 3D dynamic icon based on the flight attitude includes adjusting the roll angle and the yaw angle of the 3D dynamic icon 101 based on the roll angle and the yaw angle of the aerial vehicle 200.

In some embodiments, the pitch angle, the roll angle, and the yaw angle of the aerial vehicle 200 are obtained based on the status information. Adjusting the display attitude of the 3D dynamic icon based on the flight attitude includes adjusting the pitch angle, the roll angle, and the yaw angle of the 3D dynamic icon 101 based on the pitch angle, the roll angle, and the yaw angle of the aerial vehicle 200.

In the example methods described above, the adjustment of an angle of the 3D dynamic icon 101 may be equal to the adjustment of a corresponding angle of the aerial vehicle 200. That is, the change of the angle of the aerial vehicle 200 may be equal to the change of the corresponding angle of the 3D dynamic icon 101. For example, when the aerial vehicle 200 tilts up by about 60°, the 3D dynamic icon 101 also tilts up by about 60°. When the aerial vehicle 200 tilts down by about 60°, the 3D dynamic icon 101 also tilts down by about 60°.

In some embodiments, the adjustment of an angle of the 3D dynamic icon 101 may be proportional to the adjustment of a corresponding angle of the aerial vehicle 200 at a pre-determined ratio. For example, the pre-determined ratio may be 2:1. When the aerial vehicle 200 tilts up by about 60°, the 3D dynamic icon 101 may tilt up by about 30°. When the aerial vehicle 200 tilts down by about 60°, the 3D dynamic icon 101 may tilt down by about 30°.

In some embodiments, the adjustment of an angle of the 3D dynamic icon 101 may have a pre-determined mapping relationship with the adjustment of a corresponding angle of the aerial vehicle 200. For example, when the aerial vehicle 200 tilts up by about 60°, the 3D dynamic icon 101 may tilt up by about 30° according to a pre-determined mapping relationship. When the aerial vehicle 200 tilts down by about 60°, the 3D dynamic icon 101 may tilt down by about 30° according to the pre-determined mapping relationship.

In some embodiments, a fixed angle of the 3D dynamic icon 101 may be set for a corresponding angle of the aerial vehicle 200 in a certain range. For example, when the aerial vehicle 200 tilts up by an angle in a range between about 0° and about 30°, the 3D dynamic icon 101 may tilt up by about 15°. When the aerial vehicle 200 tilts up by an angle in a range between about 30° and about 60°, the 3D dynamic icon 101 may tilt up by about 30°. When the aerial vehicle 200 tilts up by an angle in a range between about 60° and about 90°, the 3D dynamic icon 101 may tilt up by about 60°.

When the adjustment of an angle of the 3D dynamic icon 101 is equal to the adjustment of a corresponding angle of the aerial vehicle 200, the user may synchronously perceive the attitude change of the aerial vehicle 200.

In some embodiments, the user may input various angles to control the angle adjustments. For example, the user may enter a 30° pitch angle, a 50° roll angle, and a 60° yaw angle. When the aerial vehicle 200 has a non-zero pitch angle, the 3D dynamic icon 101 may always tilt by about 30° regardless of the actual value of the pitch angle of the aerial vehicle 200. When the aerial vehicle 200 has a non-zero roll angle, the 3D dynamic icon 101 may always roll by about 50° regardless of the actual value of the roll angle of the aerial vehicle 200. When the aerial vehicle 200 has a non-zero yaw angle, the 3D dynamic icon 101 always yaws by about 60° regardless of the actual value of the yaw angle of the aerial vehicle 200.

Referring to FIG. 2, in some embodiments, the control device 110 includes a communication circuit 111, a processor 112, and a display 113. The communication circuit 111 can be configured to implement S1. The processor 112 can be configured to implement S2, S5, and S6. The display 113 can be configured to implement S3 and S7. For example, the communication circuit 111 can be configured to receive the status information of the aerial vehicle 200. The processor 112 can be configured to obtain the flight path based on the status information, to obtain the flight attitude based on the status information, and to adjust the display attitude of the 3D dynamic icon 101 based on the flight attitude. The display 113 can be configured to display the 3D dynamic icon 101 corresponding to the flight path, and to display the text information 103 corresponding to the flight attitude of the aerial vehicle 200. The processor 112 can obtain the flight path according to any of the methods described above, and adjusting the display attitude of the 3D dynamic icon 101 based on the flight attitude can be performed according to any of the methods described above, the detailed descriptions of both of which are not repeated here.

The control device 110 of the present disclosure may be implemented in the electronic device 100 of the present disclosure. The electronic device 100 may include one or more of a smart phone, a tablet computer, a remote controller (e.g., a remote controller having a display), a smart watch, smart glasses, a smart helmet, other virtual reality wearable device, other augmented reality wearable device, or other display terminal having a display function. As shown in FIGS. 15 and 16, in addition to display the 3D dynamic icon 101 corresponding to the flight path and the text information 103, the display 113 of the electronic device 100 can also display other related information of the aerial vehicle that is monitored or controlled, such as model number and parameter information of the aerial vehicle 200, flight parameters of the aerial vehicle 200, images or videos captured by the aerial vehicle 200, and interface information for controlling the aerial vehicle 200.

The following example illustrates displaying the 3D dynamic icon 101 corresponding to the flight path, adjusting the 3D dynamic icon 101 corresponding to the flight path based on the flight attitude, and displaying the text information corresponding to the flight attitude of the aerial vehicle 200. Referring to FIG. 9, a user clicks on any position of the display 113. The display 113 displays a cursor 102 that locks a direction. The communication circuit 111 receives the status information of the aerial vehicle 200. The processor 112 obtains the flight path of the aerial vehicle 200 based on the status information. The method of obtaining the flight path can be any of the methods described above. Referring to FIG. 10, the display 113 displays a 3D dynamic icon 101 corresponding to the flight path. As such, the flight path of the aerial vehicle 200 may be known by observing the 3D dynamic icon 101 displayed on the display 113.

When the flight attitude of the aerial vehicle 200 changes, the processor 112 may adjust the display attitude of the 3D dynamic icon 101 based on the flight attitude. For example, when the aerial vehicle 200 yaws and the nose of the aerial vehicle 200 faces toward a direction other than the flying direction, the processor 112 obtains the yaw angle, and correspondingly, the 3D dynamic icon 101 also yaws with a corresponding angle (as shown in FIG. 12). When the aerial vehicle 200 yaws by about 180°, correspondingly, the 3D dynamic icon 101 also yaws by about 180 (as shown in FIG. 13), and the display path of the 3D dynamic icon 101 gradually fades away at a pace proportional to the flying forward speed of the aerial vehicle 200.

The display 113 also displays text information 103 corresponding to the yawing to alert the user. For example, when the 3D dynamic icon 101 in FIG. 10 yaws to the 3D dynamic icon 101 in FIG. 15, the text information 103 “yaws by about 180°” may be displayed. Thus, the user may intuitively perceive that the aerial vehicle 200 yaws and may promptly read the corresponding text information 103 from the display 113. When the display 113 displays text information “ascending” or “descending”, the user may promptly understand that the aerial vehicle 200 is ascending or descending.

The 3D dynamic icon 101 may be in bright colors and arrow-shaped, and may gradually become narrower in a depth direction of the display 113. In some embodiments, the 3D dynamic icon 101 may include a plurality of sub-arrows that are arranged sequentially and separated from each other. In some embodiments, tips of the sub-arrows of the 3D dynamic icon 101 may fade away one by one into the flying direction. In some embodiments, the 3D dynamic icon 101 may not be in bright colors, but in somewhat vivid colors, such as visually impactful red, green, or yellow. In some embodiments, the 3D dynamic icon 101 may be in any other colors or in simple or gradient combination of a plurality of colors, as long as the sufficient indication is provided to the user. The 3D dynamic icon 101 may not be limited to arrow-shaped, but may be triangle-shaped, trapezoid-shaped, or rolling column-shaped.

The control method, the control device 110, and the electronic device 100 of the present disclosure may control the display 113 to intelligently display the 3D dynamic icon 101 showing the flight path of the aerial vehicle 200 with a perception of depth. As such, when the user monitors or operates the aerial vehicle 200, the user may perceive the depth of the view and enjoy an improved user experience. When displaying in combination with the images captured and uploaded by the aerial vehicle 200, the user may have an immersive feeling, which substantially improves the user experience. Moreover, the processor 112 may adjust the display attitude of the 3D dynamic icon 101 based on the flight attitude of the aerial vehicle 200. The display 113 may also display the text information 103 corresponding to the flight attitude to alert the user. The user may intuitively perceive the flight attitude of the aerial vehicle 200 by following the display attitude of the 3D dynamic icon 101 and promptly reading the corresponding text information 103 from the display 113. Thus, the user experience is further improved.

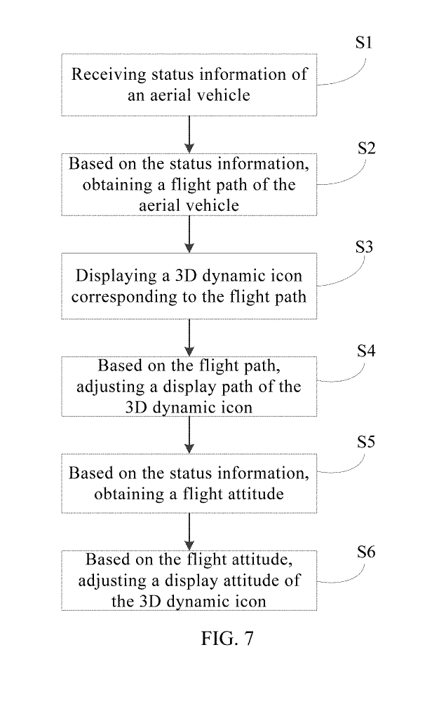

Referring to FIG. 2, FIG. 7, and FIGS. 9-11, the control method of the present disclosure is implemented in the control device 110 to control the electronic device 100. The electronic device 100 communicates with the aerial vehicle 200. The control method includes: receiving status information of the aerial vehicle 200 (S1), obtaining a flight path of the aerial vehicle 200 based on the status information (S2), displaying a 3D dynamic icon 101 corresponding to the flight path (S3), adjusting the display path of the 3D dynamic icon 101 based on the flight path (S4), obtaining a flight attitude based on the status information (S5), and adjusting the display attitude of the 3D dynamic icon 101 based on the flight attitude (S6). The process of obtaining the flight path is described in more detail below.

In some embodiments, when the aerial vehicle 200 is flying in an autonomous flight mode, the flight path of the aerial vehicle 200 may be planned in advance by an autonomous flight circuit in the aerial vehicle 200 or an autonomous flight circuit in the electronic device 100. In these embodiments, the status information may include a planned path that the autonomous flight circuit plans in advance. Correspondingly, the process of obtaining the flight path of the aerial vehicle 200 based on the status information may include directly retrieving the planned path from the status information.

In some embodiments, when the aerial vehicle 200 is flying in a manually controlled flight mode, the flight path of the aerial vehicle 200 may be predicted by a path prediction circuit of the aerial vehicle 200 according to a real-time flying path. In these embodiments, the status information may include a future path that the path prediction circuit of the aerial vehicle 200 predicts. Correspondingly, the process of obtaining the flight path of the aerial vehicle 200 based on the status information may include directly retrieving the future path from the status information.

In some embodiments, when the aerial vehicle 200 is flying in a manually controlled flight mode, the aerial vehicle 200 may record its own real-time flying path. In these embodiments, the status information may include the real-time flying path of the aerial vehicle 200. Correspondingly, the process of obtaining the flight path of the aerial vehicle 200 based on the status information may include retrieving the real-time flying path and predicting a future path of the aerial vehicle 200 based on the real-time flying path. In these embodiments, the path prediction circuit is located outside the aerial vehicle 200.

The flight attitude of the aerial vehicle 200 can include a pitch angle, a roll angle, and a yaw angle. The processes of obtaining the flight attitude and adjusting the display attitude are described in more detail below.

In some embodiments, the pitch angle of the aerial vehicle 200 is obtained based on the status information. Adjusting the display attitude of the 3D dynamic icon based on the flight attitude includes adjusting the pitch angle of the 3D dynamic icon 101 based on the pitch angle of the aerial vehicle 200.

In some embodiments, the roll angle of the aerial vehicle 200 is obtained based on the status information. Adjusting the display attitude of the 3D dynamic icon based on the flight attitude includes adjusting the roll angle of the 3D dynamic icon 101 based on the roll angle of the aerial vehicle 200.

In some embodiments, the yaw angle of the aerial vehicle 200 is obtained based on the status information. Adjusting the display attitude of the 3D dynamic icon based on the flight attitude includes adjusting the yaw angle of the 3D dynamic icon 101 based on the yaw angle of the aerial vehicle 200.

In some embodiments, the pitch angle and the roll angle of the aerial vehicle 200 are obtained based on the status information. Adjusting the display attitude of the 3D dynamic icon based on the flight attitude includes adjusting the pitch angle and the roll angle of the 3D dynamic icon 101 based on the pitch angle and the roll angle of the aerial vehicle 200.

In some embodiments, the pitch angle and the yaw angle of the aerial vehicle 200 are obtained based on the status information. Adjusting the display attitude of the 3D dynamic icon based on the flight attitude includes adjusting the pitch angle and the yaw angle of the 3D dynamic icon 101 based on the pitch angle and the yaw angle of the aerial vehicle 200.

In some embodiments, the roll angle and the yaw angle of the aerial vehicle 200 are obtained based on the status information. Adjusting the display attitude of the 3D dynamic icon based on the flight attitude includes adjusting the roll angle and the yaw angle of the 3D dynamic icon 101 based on the roll angle and the yaw angle of the aerial vehicle 200.

In some embodiments, the pitch angle, the roll angle, and the yaw angle of the aerial vehicle 200 are obtained based on the status information. Adjusting the display attitude of the 3D dynamic icon based on the flight attitude includes adjusting the pitch angle, the roll angle, and the yaw angle of the 3D dynamic icon 101 based on the pitch angle, the roll angle, and the yaw angle of the aerial vehicle 200.

In the example methods described above, the adjustment of an angle of the 3D dynamic icon 101 may be equal to the adjustment of a corresponding angle of the aerial vehicle 200. That is, the change of the angle of the aerial vehicle 200 may be equal to the change of the corresponding angle of the 3D dynamic icon 101. For example, when the aerial vehicle 200 tilts up by about 60°, the 3D dynamic icon 101 also tilts up by about 60°. When the aerial vehicle 200 tilts down by about 60°, the 3D dynamic icon 101 also tilts down by about 60°.

In some embodiments, the adjustment of an angle of the 3D dynamic icon 101 may be proportional to the adjustment of a corresponding angle of the aerial vehicle 200 at a pre-determined ratio. For example, the pre-determined ratio may be 2:1. When the aerial vehicle 200 tilts up by about 60°, the 3D dynamic icon 101 may tilt up by about 30°. When the aerial vehicle 200 tilts down by about 60°, the 3D dynamic icon 101 may tilt down by about 30°.

In some embodiments, the adjustment of an angle of the 3D dynamic icon 101 may have a pre-determined mapping relationship with the adjustment of a corresponding angle of the aerial vehicle 200. For example, when the aerial vehicle 200 tilts up by about 60°, the 3D dynamic icon 101 may tilt up by about 30° according to a pre-determined mapping relationship. When the aerial vehicle 200 tilts down by about 60°, the 3D dynamic icon 101 may tilt down by about 30° according to the pre-determined mapping relationship.

In some embodiments, a fixed angle of the 3D dynamic icon 101 may be set for a corresponding angle of the aerial vehicle 200 in a certain range. For example, when the aerial vehicle 200 tilts up by an angle in a range between about 0° and about 30°, the 3D dynamic icon 101 may tilt up by about 15°. When the aerial vehicle 200 tilts up by an angle in a range between about 30° and about 60°, the 3D dynamic icon 101 may tilt up by about 30°. When the aerial vehicle 200 tilts up by an angle in a range between about 60° and about 90°, the 3D dynamic icon 101 may tilt up by about 60°.

When the adjustment of an angle of the 3D dynamic icon 101 is equal to the adjustment of a corresponding angle of the aerial vehicle 200, the user may synchronously perceive the attitude change of the aerial vehicle 200.

In some embodiments, the user may input various angles to control the angle adjustments. For example, the user may enter a 30° pitch angle, a 50° roll angle, and a 60° yaw angle. When the aerial vehicle 200 has a non-zero pitch angle, the 3D dynamic icon 101 may always tilt by about 30° regardless of the actual value of the pitch angle of the aerial vehicle 200. When the aerial vehicle 200 has a non-zero roll angle, the 3D dynamic icon 101 may always roll by about 50° regardless of the actual value of the roll angle of the aerial vehicle 200. When the aerial vehicle 200 has a non-zero yaw angle, the 3D dynamic icon 101 always yaws by about 60° regardless of the actual value of the yaw angle of the aerial vehicle 200.

Referring to FIG. 2, in some embodiments, the control device 110 includes a communication circuit 111, a processor 112, and a display 113. The communication circuit 111 can be configured to implement S1. The processor 112 can be configured to implement S2, S4, S5, and S6. The display 113 can be configured to implement S3. For example, the communication circuit 111 can be configured to receive the status information of the aerial vehicle 200. The processor 112 can be configured to obtain the flight path based on the status information, to adjust the flight path of the 3D dynamic icon 101 based on the flight path, to obtain the flight attitude based on the status information, and to adjust the display attitude of the 3D dynamic icon 101 based on the flight attitude. The display 113 can be configured to display the 3D dynamic icon 101 corresponding to the flight path. The processor 112 can obtain the flight path according to any of the methods described above, and adjusting the display attitude of the 3D dynamic icon 101 based on the flight attitude can be performed according to any of the methods described above, the detailed descriptions of both of which are not repeated here.

The control device 110 of the present disclosure may be implemented in the electronic device 100 of the present disclosure. The electronic device 100 may include one or more of a smart phone, a tablet computer, a remote controller (e.g., a remote controller having a display), a smart watch, smart glasses, a smart helmet, other virtual reality wearable device, other augmented reality wearable device, or other display terminal having a display function. As shown in FIGS. 15 and 16, in addition to display the 3D dynamic icon 101 corresponding to the flight path, the display 113 of the electronic device 100 can also display other related information of the aerial vehicle that is monitored or controlled, such as model number and parameter information of the aerial vehicle 200, flight parameters of the aerial vehicle 200, images or videos captured by the aerial vehicle 200, and interface information for controlling the aerial vehicle 200.

The following example illustrates displaying the 3D dynamic icon 101 corresponding to the flight path and adjusting the 3D dynamic icon 101 corresponding to the flight path based on the flight path and the flight attitude. Referring to FIG. 9, a user clicks on any position of the display 113. The display 113 displays a cursor 102 that locks a direction. The communication circuit 111 receives the status information of the aerial vehicle 200. The processor 112 obtains the flight path of the aerial vehicle 200 based on the status information. The method of obtaining the flight path can be any of the methods described above. Referring to FIG. 10, the display 113 displays a 3D dynamic icon 101 corresponding to the flight path. As such, the flight path of the aerial vehicle 200 may be known by observing the 3D dynamic icon 101 displayed on the display 113.

When the flight path and the flight attitude of the aerial vehicle 200 change as shown in FIG. 11, the user may click on another position of the display 113. The flight path of the aerial vehicle 200 may change accordingly and the flight attitude may roll accordingly. The processor 112 may adjust the display path of the 3D dynamic icon 101 based on the flight path from a straight path in FIG. 10 to a curved path in FIG. 11, and may adjust the display attitude of the 3D dynamic icon 101 based on the flight attitude by rolling. Thus, the user may intuitively perceive that the flight path of the aerial vehicle 20 changes from the straight path to the curved path and the flight attitude of the aerial vehicle 200 rolls.

The 3D dynamic icon 101 may be in bright colors and arrow-shaped, and may gradually become narrower in a depth direction of the display 113. In some embodiments, the 3D dynamic icon 101 may include a plurality of sub-arrows that are arranged sequentially and separated from each other. In some embodiments, tips of the sub-arrows of the 3D dynamic icon 101 may fade away one by one into the flying direction. In some embodiments, the 3D dynamic icon 101 may not be in bright colors, but in somewhat vivid colors, such as visually impactful red, green, or yellow. In some embodiments, the 3D dynamic icon 101 may be in any other colors or in simple or gradient combination of a plurality of colors, as long as the sufficient indication is provided to the user. The 3D dynamic icon 101 may not be limited to arrow-shaped, but may be triangle-shaped, trapezoid-shaped, or rolling column-shaped.

The control method, the control device 110, and the electronic device 100 of the present disclosure may control the display 113 to intelligently display the 3D dynamic icon 101 showing the flight path of the aerial vehicle 200 with a perception of depth. As such, when the user monitors or operates the aerial vehicle 200, the user may perceive the depth of the view and enjoy an improved user experience. When displaying in combination with the images captured and uploaded by the aerial vehicle 200, the user may have an immersive feeling, which substantially improves the user experience. Moreover, the processor 112 may adjust the display path and the display attitude of the 3D dynamic icon 101 based on the flight path and the flight attitude of the aerial vehicle 200, respectively. The user may intuitively perceive the flight path and the flight attitude of the aerial vehicle 200 by following the display path and the display attitude of the 3D dynamic icon 101. Thus, the user experience is further improved.

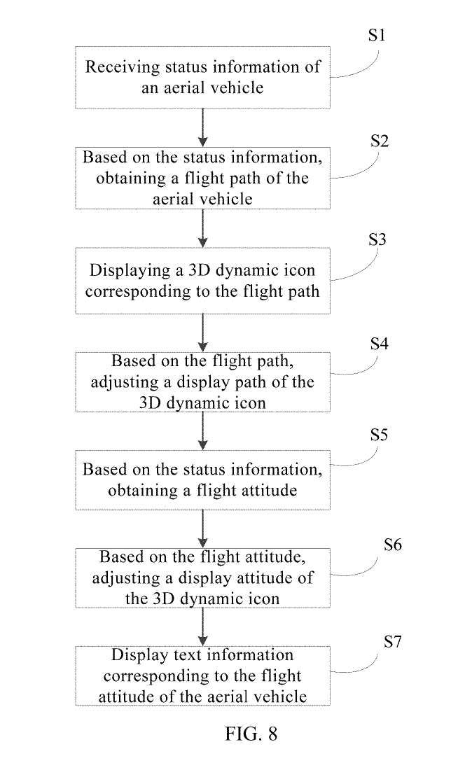

Referring to FIG. 2, and FIGS. 8-11, the control method of the present disclosure is implemented in the control device 110 to control the electronic device 100. The electronic device 100 communicates with the aerial vehicle 200. The control method includes: receiving status information of the aerial vehicle 200 (S1), obtaining a flight path of the aerial vehicle 200 based on the status information (S2), displaying a 3D dynamic icon 101 corresponding to the flight path (S3), adjusting the display path of the 3D dynamic icon 101 based on the flight path (S4), obtaining a flight attitude based on the status information (S5), adjusting the display attitude of the 3D dynamic icon 101 based on the flight attitude (S6), and displaying text information 103 corresponding to the flight attitude of the aerial vehicle 200 (S7). The process of obtaining the flight path is described in more detail below.

In some embodiments, when the aerial vehicle 200 is flying in an autonomous flight mode, the flight path of the aerial vehicle 200 may be planned in advance by an autonomous flight circuit in the aerial vehicle 200 or an autonomous flight circuit in the electronic device 100. In these embodiments, the status information may include a planned path that the autonomous flight circuit plans in advance. Correspondingly, the process of obtaining the flight path of the aerial vehicle 200 based on the status information may include directly retrieving the planned path from the status information.

In some embodiments, when the aerial vehicle 200 is flying in a manually controlled flight mode, the flight path of the aerial vehicle 200 may be predicted by a path prediction circuit of the aerial vehicle 200 according to a real-time flying path. In these embodiments, the status information may include a future path that the path prediction circuit of the aerial vehicle 200 predicts. Correspondingly, the process of obtaining the flight path of the aerial vehicle 200 based on the status information may include directly retrieving the future path from the status information.

In some embodiments, when the aerial vehicle 200 is flying in a manually controlled flight mode, the aerial vehicle 200 may record its own real-time flying path. In these embodiments, the status information may include the real-time flying path of the aerial vehicle 200. Correspondingly, the process of obtaining the flight path of the aerial vehicle 200 based on the status information may include retrieving the real-time flying path and predicting a future path of the aerial vehicle 200 based on the real-time flying path. In these embodiments, the path prediction circuit is located outside the aerial vehicle 200.

The flight attitude of the aerial vehicle 200 can include a pitch angle, a roll angle, and a yaw angle. The processes of obtaining the flight attitude and adjusting the display attitude are described in more detail below.

In some embodiments, the pitch angle of the aerial vehicle 200 is obtained based on the status information. Adjusting the display attitude of the 3D dynamic icon based on the flight attitude includes adjusting the pitch angle of the 3D dynamic icon 101 based on the pitch angle of the aerial vehicle 200.

In some embodiments, the roll angle of the aerial vehicle 200 is obtained based on the status information. Adjusting the display attitude of the 3D dynamic icon based on the flight attitude includes adjusting the roll angle of the 3D dynamic icon 101 based on the roll angle of the aerial vehicle 200.

In some embodiments, the yaw angle of the aerial vehicle 200 is obtained based on the status information. Adjusting the display attitude of the 3D dynamic icon based on the flight attitude includes adjusting the yaw angle of the 3D dynamic icon 101 based on the yaw angle of the aerial vehicle 200.

In some embodiments, the pitch angle and the roll angle of the aerial vehicle 200 are obtained based on the status information. Adjusting the display attitude of the 3D dynamic icon based on the flight attitude includes adjusting the pitch angle and the roll angle of the 3D dynamic icon 101 based on the pitch angle and the roll angle of the aerial vehicle 200.

In some embodiments, the pitch angle and the yaw angle of the aerial vehicle 200 are obtained based on the status information. Adjusting the display attitude of the 3D dynamic icon based on the flight attitude includes adjusting the pitch angle and the yaw angle of the 3D dynamic icon 101 based on the pitch angle and the yaw angle of the aerial vehicle 200.

In some embodiments, the roll angle and the yaw angle of the aerial vehicle 200 are obtained based on the status information. Adjusting the display attitude of the 3D dynamic icon based on the flight attitude includes adjusting the roll angle and the yaw angle of the 3D dynamic icon 101 based on the roll angle and the yaw angle of the aerial vehicle 200.

In some embodiments, the pitch angle, the roll angle, and the yaw angle of the aerial vehicle 200 are obtained based on the status information. Adjusting the display attitude of the 3D dynamic icon based on the flight attitude includes adjusting the pitch angle, the roll angle, and the yaw angle of the 3D dynamic icon 101 based on the pitch angle, the roll angle, and the yaw angle of the aerial vehicle 200.

In the example methods described above, the adjustment of an angle of the 3D dynamic icon 101 may be equal to the adjustment of a corresponding angle of the aerial vehicle 200. That is, the change of the angle of the aerial vehicle 200 may be equal to the change of the corresponding angle of the 3D dynamic icon 101. For example, when the aerial vehicle 200 tilts up by about 60°, the 3D dynamic icon 101 also tilts up by about 60°. When the aerial vehicle 200 tilts down by about 60°, the 3D dynamic icon 101 also tilts down by about 60°.

In some embodiments, the adjustment of an angle of the 3D dynamic icon 101 may be proportional to the adjustment of a corresponding angle of the aerial vehicle 200 at a pre-determined ratio. For example, the pre-determined ratio may be 2:1. When the aerial vehicle 200 tilts up by about 60°, the 3D dynamic icon 101 may tilt up by about 30°. When the aerial vehicle 200 tilts down by about 60°, the 3D dynamic icon 101 may tilt down by about 30°.

In some embodiments, the adjustment of an angle of the 3D dynamic icon 101 may have a pre-determined mapping relationship with the adjustment of a corresponding angle of the aerial vehicle 200. For example, when the aerial vehicle 200 tilts up by about 60°, the 3D dynamic icon 101 may tilt up by about 30° according to a pre-determined mapping relationship. When the aerial vehicle 200 tilts down by about 60°, the 3D dynamic icon 101 may tilt down by about 30° according to the pre-determined mapping relationship.

In some embodiments, a fixed angle of the 3D dynamic icon 101 may be set for a corresponding angle of the aerial vehicle 200 in a certain range. For example, when the aerial vehicle 200 tilts up by an angle in a range between about 0° and about 30°, the 3D dynamic icon 101 may tilt up by about 15°. When the aerial vehicle 200 tilts up by an angle in a range between about 30° and about 60°, the 3D dynamic icon 101 may tilt up by about 30°. When the aerial vehicle 200 tilts up by an angle in a range between about 60° and about 90°, the 3D dynamic icon 101 may tilt up by about 60°.

When the adjustment of an angle of the 3D dynamic icon 101 is equal to the adjustment of a corresponding angle of the aerial vehicle 200, the user may synchronously perceive the attitude change of the aerial vehicle 200.

In some embodiments, the user may input various angles to control the angle adjustments. For example, the user may enter a 30° pitch angle, a 50° roll angle, and a 60° yaw angle. When the aerial vehicle 200 has a non-zero pitch angle, the 3D dynamic icon 101 may always tilt by about 30° regardless of the actual value of the pitch angle of the aerial vehicle 200. When the aerial vehicle 200 has a non-zero roll angle, the 3D dynamic icon 101 may always roll by about 50° regardless of the actual value of the roll angle of the aerial vehicle 200. When the aerial vehicle 200 has a non-zero yaw angle, the 3D dynamic icon 101 always yaws by about 60° regardless of the actual value of the yaw angle of the aerial vehicle 200.

Referring to FIG. 2, in some embodiments, the control device 110 includes a communication circuit 111, a processor 112, and a display 113. The communication circuit 111 can be configured to implement S1. The processor 112 can be configured to implement S2, S4, S5, and S6. The display 113 can be configured to implement S3 and S7. For example, the communication circuit 111 can be configured to receive the status information of the aerial vehicle 200. The processor 112 can be configured to obtain the flight path based on the status information, to display the flight path of the 3D dynamic icon 101 based on the flight path, to obtain the flight attitude based on the status information, and to adjust the display attitude of the 3D dynamic icon 101 based on the flight attitude. The display 113 can be configured to display the 3D dynamic icon 101 corresponding to the flight path, and to display the text information 103 corresponding to the flight attitude of the aerial vehicle 200. The processor 112 can obtain the flight path according to any of the methods described above, and adjusting the display attitude of the 3D dynamic icon 101 based on the flight attitude can be performed according to any of the methods described above, the detailed descriptions of both of which are not repeated here.

The control device 110 of the present disclosure may be implemented in the electronic device 100 of the present disclosure. The electronic device 100 may include one or more of a smart phone, a tablet computer, a remote controller (e.g., a remote controller having a display), a smart watch, smart glasses, a smart helmet, other virtual reality wearable device, other augmented reality wearable device, or other display terminal having a display function. As shown in FIGS. 15 and 16, in addition to display the 3D dynamic icon 101 corresponding to the flight path and the text information 103, the display 113 of the electronic device 100 can also display other related information of the aerial vehicle that is monitored or controlled, such as model number and parameter information of the aerial vehicle 200, flight parameters of the aerial vehicle 200, images or videos captured by the aerial vehicle 200, and interface information for controlling the aerial vehicle 200.

The following example illustrates displaying the 3D dynamic icon 101 corresponding to the flight path, adjusting the 3D dynamic icon 101 corresponding to the flight path based on the flight path and the flight attitude, and displaying the text information corresponding to the flight attitude of the aerial vehicle 200. Referring to FIG. 9, a user clicks on any position of the display 113. The display 113 displays a cursor 102 that locks a direction. The communication circuit 111 receives the status information of the aerial vehicle 200. The processor 112 obtains the flight path of the aerial vehicle 200 based on the status information. The method of obtaining the flight path can be any of the methods described above. Referring to FIG. 10, the display 113 displays a 3D dynamic icon 101 corresponding to the flight path. As such, the flight path of the aerial vehicle 200 may be known by observing the 3D dynamic icon 101 displayed on the display 113.

When the flight path of the aerial vehicle 200 changes as shown in FIG. 11, the user may click on another position of the display 113. The flight path of the aerial vehicle 200 may change accordingly and the flight attitude may roll accordingly. The processor 112 may adjust the display path of the 3D dynamic icon 101 based on the flight path from a straight path in FIG. 10 to a curved path in FIG. 11, and may adjust the display attitude of the 3D dynamic icon 101 based on the flight attitude by rolling. Thus, the user may intuitively perceive that the flight path of the aerial vehicle 20 changes from the straight path to the curved path and the flight attitude of the aerial vehicle 200 rolls.

The display 113 also displays text information 103 corresponding to the yawing to alert the user, i.e., displaying the text information 103 “rolling by about 60°”. Thus, the user may intuitively perceive that the flight path of the aerial vehicle 200 changes from the straight path to the curved path and the flight attitude of the aerial vehicle 200 rolls. The user may also promptly read the corresponding text information 103 from the display 113. When the display 113 displays text information “ascending” or “descending”, the user may promptly understand that the aerial vehicle 200 is ascending or descending.

The 3D dynamic icon 101 may be in bright colors and arrow-shaped, and may gradually become narrower in a depth direction of the display 113. In some embodiments, the 3D dynamic icon 101 may include a plurality of sub-arrows that are arranged sequentially and separated from each other. In some embodiments, tips of the sub-arrows of the 3D dynamic icon 101 may fade away one by one into the flying direction. In some embodiments, the 3D dynamic icon 101 may not be in bright colors, but in somewhat vivid colors, such as visually impactful red, green, or yellow. In some embodiments, the 3D dynamic icon 101 may be in any other colors or in simple or gradient combination of a plurality of colors, as long as the sufficient indication is provided to the user. The 3D dynamic icon 101 may not be limited to arrow-shaped, but may be triangle-shaped, trapezoid-shaped, or rolling column-shaped.

The control method, the control device 110, and the electronic device 100 of the present disclosure may control the display 113 to intelligently display the 3D dynamic icon 101 showing the flight path of the aerial vehicle 200 with a perception of depth. As such, when the user monitors or operates the aerial vehicle 200, the user may perceive the depth of the view and enjoy an improved user experience. When displaying in combination with the images captured and uploaded by the aerial vehicle 200, the user may have an immersive feeling, which substantially improves the user experience. Moreover, the processor 112 may adjust the display path and the display attitude of the 3D dynamic icon 101 based on the flight path and the flight attitude of the aerial vehicle 200, respectively. The display 113 may also display the text information 103 corresponding to the flight attitude to alert the user. The user may intuitively perceive the flight path and the flight attitude of the aerial vehicle 200 by following the display path and the display attitude of the 3D dynamic icon 101 and promptly reading the corresponding text information 103 from the display 113. Thus, the user experience is further improved.

In the specification of the present disclosure, the reference terms “embodiments”, “one embodiment”, “some embodiments”, “example embodiments”, “example”, “specific example”, or “examples” refer to at least one embodiment or example that includes the features, structures, materials, or characteristics described in the specification. In the specification, the terms are not intended to illustrate the same embodiment or example. Moreover, the described features, structures, materials, or characteristics may be combined in one or more embodiments or example.

Any process or method description in flow charts or other descriptions may be construed to include one or more modules, segments, or portions of executable instruction codes to implement certain logical functions or steps of processes. The scope of the embodiments of the present disclosure may include other implementations in sequences other than what have been shown or described, including but not limited to executing functions in a substantially concurrent or reversed sequence. It should be understood by those skilled in the art to which the embodiments of the present disclosure belong.

The logic and/or steps illustrated in flow charts or other descriptions may be considered a sequence listing of executable instructions to implement the logic functions, and may be stored in any computer readable medium for execution by an instruction execution system, apparatus or device (e.g., a processor, a computer system, a microprocessor base system, or any other system that retrieves instructions from the instruction execution system, apparatus or device and executes the instructions), or for integration with the instruction execution system, apparatus or device. Under the context of the specification, “computer readable medium” may be any device that includes, stores, communicates, broadcasts, or transmits programs for execution by the instruction execution system, apparatus or device, or for integration with the instruction execution system, apparatus or device. Examples of the computer readable medium may include, but not limited to, an electrical connection having one or more electrical wires (electronic device), a portable computer disk cartridge (magnetic device), a random access memory (RAM), a read-only memory (ROM), an erasable programmable read-only memory (EPROM or flash memory), fiber optic device, and portable compact disk read-only memory (CD-ROM). In addition, the computer readable medium may even include paper or other suitable medium on which the programs can be printed. For example, the paper or other suitable medium may be optically scanned, edited, interpreted, or when necessary, processed in other methods to electronically obtain the programs. The programs may be stored in the computer memory.

It should be understood that, various portions of the present disclosure may be implemented by hardware, software, firmware, or a combination thereof. In some embodiments, multiple steps or methods may be stored in the memory and may be implemented by software or firmware executed by a suitable instruction execution system. For example, when implemented by hardware, in some embodiments, the implementation hardware may include any one or combination of the following technologies well known in the art: discrete logic circuits of logic gates implementing logic functions on digital signals, application specific integrated circuits of suitable combination logic gates, programmable gate array (PGA), or field programmable gate array (FPGA).

Those of ordinary skill in the art may understand that all or a portion of the steps of various embodiments may be implemented by programs to be executed by hardware. The programs may be stored in the computer readable storage medium. When the programs are executed, the execution implements one or a combination of the steps of the embodiments of the present disclosure.

In addition, each of the circuits of various embodiments may be integrated into one processing circuit, or may be physically separated. Two or more sub-circuits may be integrated into one circuit. The integrated circuits may be implemented by hardware or by software functional modules. When the integrated circuits are implemented by software functional modules, and sold or used as separate products, the integrated circuits may be stored in the computer readable storage medium.

The storage medium may include a read-only memory, a magnetic disk, or an optical disk.

The present disclosure also provides an apparatus including a processor and a storage medium storing instructions that, when executed by the processor, cause the processor to execute a method consistent with the disclosure, such as one of the example methods described above.

It should be understood by those skilled in the art that the present disclosure is not limited to the specific embodiments described herein and that various other obvious changes, rearrangements, and substitutions will occur to those skilled in the art without departing from the scope of the disclosure. Thus, while the present disclosure has been described in detail with reference to the above described embodiments, the present disclosure is not limited to the above described embodiments, but may be embodied in other equivalent forms without departing from the scope of the present disclosure, which is determined by the appended claims.

What is claimed is:

1. A control method comprising:
receiving status information of an aerial vehicle;
obtaining, based on the status information, a flight path of the aerial vehicle; and
displaying a three-dimensional (3D) dynamic icon corresponding to the flight path.

2. The method of claim 1, further comprising:
adjusting, based on the flight path, a display path of the 3D dynamic icon.

3. The method of claim 1, wherein:
the status information includes a planned path in an autonomous flight mode; and
obtaining the flight path of the aerial vehicle includes retrieving the planned path from the status information.

4. The method of claim 1, wherein:
the status information includes a future path predicted by the aerial vehicle in a manually controlled flight mode; and
obtaining the flight path of the aerial vehicle includes retrieving the future path from the status information.

5. The method of claim 1, wherein:
the status information includes a real-time path of the aerial vehicle in a manually controlled flight mode; and
obtaining the flight path of the aerial vehicle includes retrieving the real-time path from the status information and predicting a future path of the aerial vehicle based on the real-time path.

6. The method of claim 1, wherein the 3D dynamic icon is arrow-shaped, and gradually becomes narrower in a depth direction of the display.

7. The method of claim 1, wherein the 3D dynamic icon is in one or more bright colors.

8. The method of claim 1, wherein:
the 3D dynamic icon includes a plurality of sub-arrows that are arranged sequentially and separated from each other; and
the sub-arrows of the 3D dynamic icon fade away one by one into a flying direction of the aerial vehicle.

9. The method of claim 1,
wherein the status information includes a flight attitude;
the control method further comprising:
obtaining, based on the status information, the flight attitude; and
adjusting, based on the flight attitude, a display attitude of the 3D dynamic icon.

10. The method of claim 9, wherein:
the flight attitude includes at least one of a pitch angle, a roll angle, or a yaw angle of the aerial vehicle; and
adjusting the display attitude of the 3D dynamic icon includes adjusting at least one of a pitch angle, a roll angle, or a yaw angle of the 3D dynamic icon based on the at least one of the pitch angle, the roll angle, or the yaw angle of the aerial vehicle.

11. A control device comprising:
a communication circuit configured to receive status information of an aerial vehicle;
a processor configured to obtain a flight path of the aerial vehicle based on the status information; and
a display configured to display a three-dimensional (3D) dynamic icon corresponding to the flight path.

12. The device of claim 11, wherein the processor is further configured to adjust a display path of the 3D dynamic icon based on the flight path.

13. The device of claim 11, wherein:
the status information includes a planned path in an autonomous flight mode; and
the processor is further configured to obtain the flight path of the aerial vehicle by retrieving the planned path from the status information.

14. The device of claim 11, wherein:
the status information includes a future path predicted by the aerial vehicle in a manually controlled flight mode; and
the processor is further configured to obtain the flight path of the aerial vehicle by retrieving the future path from the status information.

15. The device of claim 11, wherein:
the status information includes a real-time path of the aerial vehicle in a manually controlled flight mode; and
the processor is further configured to obtain the flight path of the aerial vehicle by retrieving the real-time path from the status information and predicting a future path of the aerial vehicle based on the real-time path.

16. The device of claim 11, wherein the 3D dynamic icon is arrow-shaped, and gradually becomes narrower in a depth direction of the display.

17. The device of claim 11, wherein the 3D dynamic icon is in one or more bright colors.

18. The device of claim 11, wherein:
the 3D dynamic icon includes a plurality of sub-arrows that are arranged sequentially and separated from each other; and
the sub-arrows of the 3D dynamic icon fade away one by one into a flying direction of the aerial vehicle.

19. The device of claim 11, wherein:
the status information includes a flight attitude; and
the processor is further configured to:
obtain, based on the status information, the flight attitude; and
adjust, based on the flight attitude, a display attitude of the 3D dynamic icon.

20. The device of claim 19, wherein:
the flight attitude includes at least one of a pitch angle, a roll angle, or a yaw angle of the aerial vehicle; and
the processor is further configured to adjust the display attitude of the 3D dynamic icon by adjusting at least one of a pitch angle, a roll angle, or a yaw angle of the 3D dynamic icon based on the at least one of the pitch angle, the roll angle, or the yaw angle of the aerial vehicle.
